(19) United States
(12) Patent Application Publication
(10) Pub. No.: US 2023/0367468 A1
(43) Pub. Date: Nov. 16, 2023

(54) INFORMATION PROCESSING DEVICE, INFORMATION PROCESSING METHOD, AND INFORMATION PROCESSING PROGRAM

(71) Applicant: SONY GROUP CORPORATION, TOKYO (JP)

(72) Inventors: KENTO TAKURA, TOKYO (JP); KUMIKO SO, TOKYO (JP); SHO KOBAYASHI, TOKYO (JP); KEIJI SASAKI, TOKYO (JP); FUMIHIKO NISHIO, TOKYO (JP); HYUMIN SEUL, TOKYO (JP); TAISUKE ONISHI, TOKYO (JP)

(21) Appl. No.: 18/044,248

(22) PCT Filed: Sep. 15, 2021
(86) PCT No.: PCT/JP2021/033939

§ 371 Date: Mar. 7, 2023

(30) Foreign Application Priority Data
Sep. 16, 2020 (JP) 2020-155822

(51) Int. Cl. G06F 3/04847; G06F 3/04845; G06F 3/0482

(52) U.S. Cl. CPC G06F 3/04847; G06F 3/04845; G06F 3/0482; G06F 2203/04804; G06F 9/451

(57) ABSTRACT

To further improve usability. An information processing device (10) includes a control unit (190) that executes a process of activating a second application for setting related to the operation of a first application, displaying a screen of the first application and superimposing a menu for changing the setting of the second application on a part of the screen, and operating the first application and the second application independently.

### FIELD

The present disclosure relates to an information processing device, an information processing method, and an information processing program.

### BACKGROUND

In recent users' installation of various applications on terminals such as personal computers or smartphones, not only one application but also a plurality of applications is used in combination to obtain user experience.

### CITATION LIST

### Patent Literature

Patent Literature 1: JP 2017-188833 A

### SUMMARY

### Technical Problem

However, the conventional technology has room for further improvement in usability to obtain comfortable user experience.

Therefore, the present disclosure proposes a novel and improved information processing device, information processing method, and information processing program that are configured to further improve usability.

### Solution to Problem

According to the present disclosure, an information processing device is provided that include a control unit that executes a process of: activating a second application for setting related to the operation of a first application; displaying a screen of the first application and superimposing a menu for changing the setting of the second application on a part of the screen; and operating the first application and the second application independently.

Moreover, according to the present disclosure, an information processing method includes an information processing device that executes a process of: activating a second application for setting related to the operation of a first application; displaying a screen of the first application and superimposing a menu for changing the setting of the second application on a part of the screen; and operating the first application and the second application independently.

Moreover, according to the present disclosure, an information processing program causes an information processing device to execute a process of: activating a second application for setting related to the operation of a first application; displaying a screen of the first application and superimposing a menu for changing the setting of the second application on a part of the screen; and operating the first application and the second application independently.

### BRIEF DESCRIPTION OF DRAWINGS

FIG. 1 is a block diagram illustrating an exemplary functional configuration of an information processing device 10 according to the present embodiment.

FIG. 2 is a diagram illustrating an example of an operation related to UI display for an extension application according to the embodiment.

FIG. 3 is a diagram illustrating an example of an operation related to the UI display for the extension application according to the embodiment.

FIG. 4 is a diagram illustrating an example of an operation related to the UI display for the extension application according to the embodiment.

FIG. 5 is a block diagram illustrating an exemplary hardware configuration of the information processing device 10 according to an embodiment of the present disclosure.

### DESCRIPTION OF EMBODIMENTS

Preferred embodiments of the present disclosure will be described in detail below with reference to the accompanying drawings. Note that in the present description and the drawings, component elements having substantially the same functional configurations are denoted by the same reference symbols and numerals, and redundant descriptions thereof will be omitted.

Note that the description will be given in the following order.
1. Embodiment
1.1. Introduction
1.2. Exemplary functional configuration
1.3. Functional details
2. Modifications of Embodiment
3. Exemplary hardware configuration
4. Conclusion

### 1. EMBODIMENT

### 1.1. Introduction

In recent user's installation of various applications on terminals such as personal computers or smartphones, not only one application but also a plurality of applications is used in combination to obtain user experience.

For example, the user captures a moving image or image on a play screen of a game application with a camera application. The captured moving image or image is subjected to processing or the like by another application and distributed on a net or published on a Web site via a Web service or another application. In this way, the user tries to obtain new user experience using other applications so as to extend one application.

In addition, when other applications are used to extend one application, it is important to prevent interference with display and operation of the applications as much as possible in order to obtain comfortable user experience. For example, interference of a user interface (UI) of the camera application with the play of the game application would considerably impair comfortable user experience. On the other hand, making it difficult to capture an image with the camera application in order to give priority to the play of the game application may miss the decisive moment for capturing the play screen. Note that such a problem is caused not in the case of using a specific application such as the game application or the camera application, but also in a case the user uses various applications in combination.

Therefore, the present disclosure proposes a novel and improved information processing device, information processing method, and information processing program that are configured to further improve usability.

### 1.2. Exemplary Functional Configuration

First, an exemplary functional configuration of an information processing device 10 according to the present embodiment will be described. The information processing device 10 may be a mobile terminal such as a smartphone or tablet personal computer (PC) configured to run various applications, or may be a stationary terminal installed at the user's home, office, or the like.

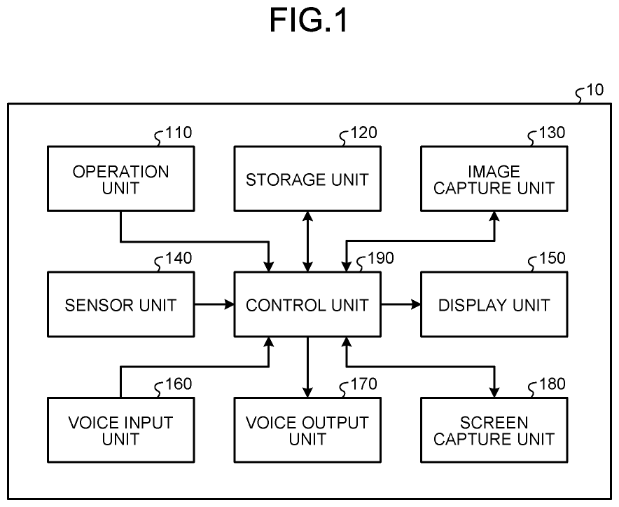

FIG. 1 is a block diagram illustrating the exemplary functional configuration of the information processing device 10 according to the present embodiment. As illustrated in FIG. 1, the information processing device 10 according to the present embodiment includes an operation unit 110, a storage unit 120, an image capture unit 130, a sensor unit 140, a display unit 150, a voice input unit 160, a voice output unit 170, a screen capture unit 180, and a control unit 190.

(Operation Unit 110)

The operation unit 110 according to the present embodiment detects various operations by the user, such as device operations for each application. The device operations include touch interactions, insertion of an earphone terminal into the information processing device 10, and the like. Here, the touch interactions refer to various touch operations to the display unit 150, for example, tap, double-tap, swipe, pinch, and the like. In addition, the touch interaction includes an operation of approaching of an object, such as a finger, to the display unit 150. Therefore, the operation unit 110 according to the present embodiment includes, for example, a touch-screen, a button, a keyboard, a mouse, a proximity sensor, or the like. The operation unit 110 according to the present embodiment inputs information about the detected operations by the user to the control unit 190.

(Storage Unit 120)

The storage unit 120 according to the present embodiment is a storage area for temporarily or permanently storing various programs and data. For example, the storage unit 120 may store programs and data for performing various functions of the information processing device 10. In a specific example, the storage unit 120 may store programs for running various applications, management data for managing various settings, and the like. As a matter of course, the above description is merely an example, and the type of data to be stored in the storage unit 120 is not particularly limited.

(Image Capture Unit 130)

The image capture unit 130 according to the present embodiment captures, for example, an image of the face or the like of the user who operates the information processing device 10 under control by the control unit 190. Therefore, the image capture unit 130 according to the present embodiment includes an imaging element. A smartphone, which is an example of the information processing device 10, includes a front camera for capturing an image of a user's face or the like on the side of the display unit 150 and a main camera for capturing an image of a landscape or the like on the back side of the display unit 150. In the present embodiment, capturing the image with the front camera is controlled in an example.

(Sensor Unit 140)

The sensor unit 140 according to the present embodiment has a function of collecting sensor information about user's behaviors by using various sensors. The sensor unit 140 includes, for example, an acceleration sensor, a gyro sensor, a geomagnetic sensor, a vibration sensor, a global navigation satellite system (GNSS) signal reception device, and the like. For example, the sensor unit 140 detects that the user turns the information processing device 10 sideways, by using a gyro sensor, and inputs the detected information to the control unit 190.

(Display Unit 150)

The display unit 150 according to the present embodiment displays various visual information under the control by the control unit 190. The display unit 150 according to the present embodiment may display, for example, an image, characters, or the like related to each application. Therefore, the display unit 150 according to the present embodiment includes various display devices such as a liquid crystal display (LCD) device and an organic light emitting diode (OLED) display device. Furthermore, the display unit 150 is also configured to superimpose and display UI for another application on a layer above the screen of an application being displayed.

(Voice Input Unit 160)

The voice input unit 160 according to the present embodiment collects voice or the like of the user under the control by the control unit 190. Therefore, the voice input unit 160 according to the present embodiment includes a microphone or the like.

(Voice Output Unit 170)

The voice output unit 170 according to the present embodiment outputs various voices. The voice output unit 170 according to the present embodiment outputs voice and sound according to the situation of each application, for example, under the control by the control unit 190. Therefore, the voice output unit 170 according to the present embodiment includes a speaker and an amplifier.

(Screen Capture Unit 180)

The screen capture unit 180 according to the present embodiment captures a screenshot (SS) and a moving image on a displayed screen on the display unit 150, under the control of the control unit 190, and stores the images in the storage unit 120.

(Control Unit 190)

The control unit 190 according to the present embodiment controls each configuration included in the information processing device 10. In addition, one of the features of the control unit 190 according to the present embodiment is to control functional extension for each application. Note that the functional extension for the application is performed by another application (here, in order to distinguish between an application for which the functional extension is performed and another application performing the functional extension, the application for which the functional extension is performed is referred to as an “external application” (an example of a first application) and the another application performing the functional extension is referred to as an “extension application” (an example of a second application), respectively). Upon functional extension, the control unit 190 activates the extension application in addition to the external application, and simultaneously controls both applications. The functions of the control unit 190 according to the present embodiment will be described in detail later.

The exemplary functional configuration of the information processing device 10 according to the present embodiment has been described. Note that the configuration described above with reference to FIG. 1 is merely an example, and the functional configuration of the information processing device 10 according to the present embodiment is not limited to such an example. For example, the information processing device 10 may not necessarily include all of the configurations illustrated in FIG. 1, and each configuration such as the voice input unit 160 may be included in another device different from the information processing device 10. The functional configuration of the information processing device 10 according to the present embodiment can be flexibly modified according to specifications or operations.

In addition, an arithmetic device such as a central proccessing unit (CPU) may perform the function of each component element by reading a control program from a storage medium such as a read only memory (ROM) or random access memory (RAM) storing control programs in which process procedures to implement the functions of the component elements are described, and by interpreting and performing the program. Therefore, it is possible to appropriately change the configuration to be used, according to technical level, whenever the present embodiment is carried out. Furthermore, an example of a hardware configuration of the information processing device 10 will be described later.

### 1.3. Functional Details

Next, functions of the information processing device 10 according to the present embodiment will be described in detail. One of the features of the control unit 190 of the information processing device 10 according to the present embodiment is to control the extension applications that provide extended functions to various external applications. The external application is, for example, a game application. However, the external application is not limited to the game application, and includes various applications installed on the information processing device 10 and used by the user, such as a drawing application, an editing application, or a music application, the music application being used for viewing and listening a moving image, music, and the like.

The extension application according to the present embodiment facilitates provision of the extended functions to various external applications without editing a source code, or the like. In addition, the extension application is configured to operate so as not to interfere with a user operation on the external application or OS, or a behavior of the external application, when the extended function is provided.

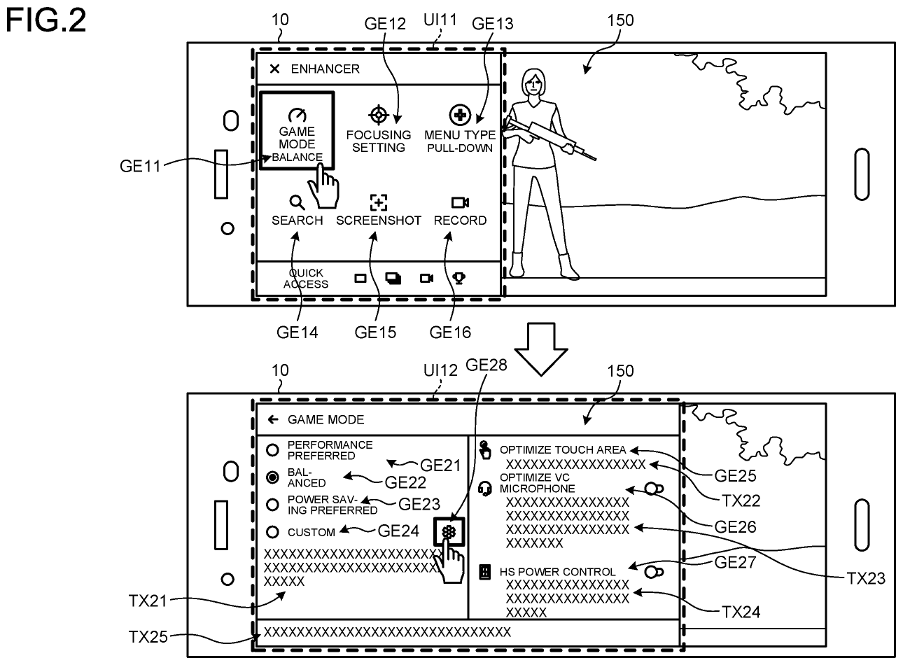

Operations related to menu display of the extension application according to the present embodiment will be described below with reference to FIGS. 2 to 4. In FIGS. 2 to 4, the sensor unit 140 detects that the information processing device 10 is turned sideways by the user, and the screen on the display unit 150 is displayed in a landscape mode by the control unit 190.

FIG. 2 is a diagram illustrating an example of an operation related to the menu display of the extension application according to the present embodiment. The upper drawing of FIG. 2 illustrates a state in which the control unit 190 has already activated the external application (here, the game application) and has caused the display unit 150 to display a screen of the external application in full screen. The upper drawing of FIG. 2 illustrates a state in which the extension application is activated while the user is playing the external application. Note that, as illustrated in the upper drawing of FIG. 2, in a case where a game environment can be made comfortable by the extension application, the extension application is hereinafter appropriately referred to as Enhancer.

Hereinafter, in the present embodiment, when the user activates the extension application while playing the external application, the external application and the extension application are controlled by the control unit 190 to operate independently. In other words, the control unit 190 controls both the external application and the extension application in a manner that the user can simultaneously operate both of the applications. In this way, even while the user operates the extension application, the operation of the external application proceeds, and thus, the user can operate the external application while operating the extension application. In addition, the change of the settings for the extension application is immediately reflected in the external application. Therefore, the user can appropriately search for optimum setting values according to immersive feeling while playing the game.

The display unit 150 in the upper drawing of FIG. 2 displays UI 11 for the extension application performing the functional extension for the external application. Note that an operation for displaying the UI 11 is, for example, a user's touch interaction on the display unit 150, such as tapping an icon or calling a pull-down menu. Here, the extension application may be activated by detecting activation of the external application by the control unit 190, or may be activated by detecting any operation during activation of the external application. The any operation is, for example, a user's operation detected by the operation unit 110 or the sensor unit 140, a voice operation recognized by the voice input unit 160, or the like. Furthermore, the extension application may be automatically activated with activation of the OS of the information processing device 10. Alternatively, the extension application may be activated, such as by user's pressing an icon for the extension application displayed on the display unit 150.

There is a case where while the external application is being activated, the extension application is also being activated as described above, but the UI for the extension application may not be displayed in principle, when the user is not using the extension application. Note that a logo or the like may be displayed when the extension application is activated but, for example, control such as automatic disappearance of the logo after a certain period of time may be performed by the control unit 190. Therefore, when the user is using no extension application, the extension application can operate so as not to interfere with the user's operation on the external application or OS or the behavior of the external application.

In the upper drawing of FIG. 2, the UI 11 displayed on the display unit 150 includes a plurality of items (GE11 to GE16) of a game mode, focus setting, a menu type, search, screenshot, and record. The item GE11 of these items is, for example, an icon for displaying UI 12 for the game mode of the extension application. Note that the above is an example, and the type, the number, the display mode, and the like of the items displayed in the UI 11 are not particularly limited. The upper drawing of FIG. 2 illustrates a state in which the user is about to perform the touch interaction on the display unit 150 in order to use the game mode of the extension application. Note that a hand icon in the drawing represents a hand of the user who is about to perform the touch interaction. Subsequently, the lower drawing of FIG. 2 illustrates a state in which the UI 12 for the game mode of the extension application is superimposed and displayed on the external application by the user's touch interaction on the item GE11 displayed on the display unit 150. In other words, the user's touch interaction on the item GE11 causes transition of a screen (UI screen) of the extension application, from the UI 11 to the UI 12. Note that the transition of the UI screen according to the present embodiment is controlled by the control unit 190.

The display unit 150 in the lower drawing of FIG. 2 displays the UI 12 for the game mode of the extension application. In the lower drawing of FIG. 2, the UI 12 displayed on the display unit 150 includes a plurality of items (GE21 to GE24) of performance preferred, balance, power saving preferred, and custom. The item GE24 of these items is, for example, an item for setting the operation of the extension application to custom settings stored in the storage unit 120. The lower drawing of FIG. 2 illustrates an example of a state of selecting the balance from the GE21 to GE24. Furthermore, in the lower drawing of FIG. 2, the UI 12 displayed on the display unit 150 includes a plurality of items (GE25 to GE27) of optimize touch area, optimize VC microphone, and HS power control. In the lower drawing of FIG. 2, the GE25 to GE27 are selected by being turned on or off. Note that the above is an example, and the type, the number, the display mode, and the like of the items displayed in the UI 12 are not particularly limited.

In the lower drawing of FIG. 2, the UI 12 displayed on the display unit 150 includes a plurality of texts (TX21 to TX25). The text TX21 is a text for supporting the selection of the item (GE21 to GE24), and shows, for example, “The stamina mode is ineffective while you use the Enhancer. If you want to give priority to the battery life, select ‘power saving preferred’.” Furthermore, the text TX22 is a text for supporting setting of optimize touch area (item GE25), and shows, for example, “OFF/This function is invalid in the portrait mode.”

The text TX23 is a text for supporting the setting of the optimize VC microphone (item GE26), and shows, for example, “If you use a headset having a microphone at the mouth, such as a gaming headset, to have a voice chat, it is easy for the others to hear your voice.” Furthermore, the text TX24 is a text for supporting the setting of the HS power control (item GE27), and shows, for example, “suppresses performance deterioration and battery deterioration due to high temperature during charging.” Furthermore, the text TX25 is a text for supporting the setting of the game mode (item GE11), and shows, for example, “This setting is effective only during this game.”

In the lower drawing of FIG. 2, the UI 12 displayed on the display unit 150 includes a gear icon (item GE28) positioned on the right side of the custom (item GE24). The item GE28 is an icon for displaying UI 13 for the custom settings of the extension application. The item GE28 is not limited to the gear icon, and the display mode thereof is not particularly limited. A display position of the item GE28 is also not particularly limited. Furthermore, the lower drawing of FIG. 2 illustrates a state in which the user is about to perform the touch interaction on the display unit 150 in order to use the custom settings of the extension application. Note that a hand icon in the drawing represents a hand of the user who is about to perform the touch interaction.

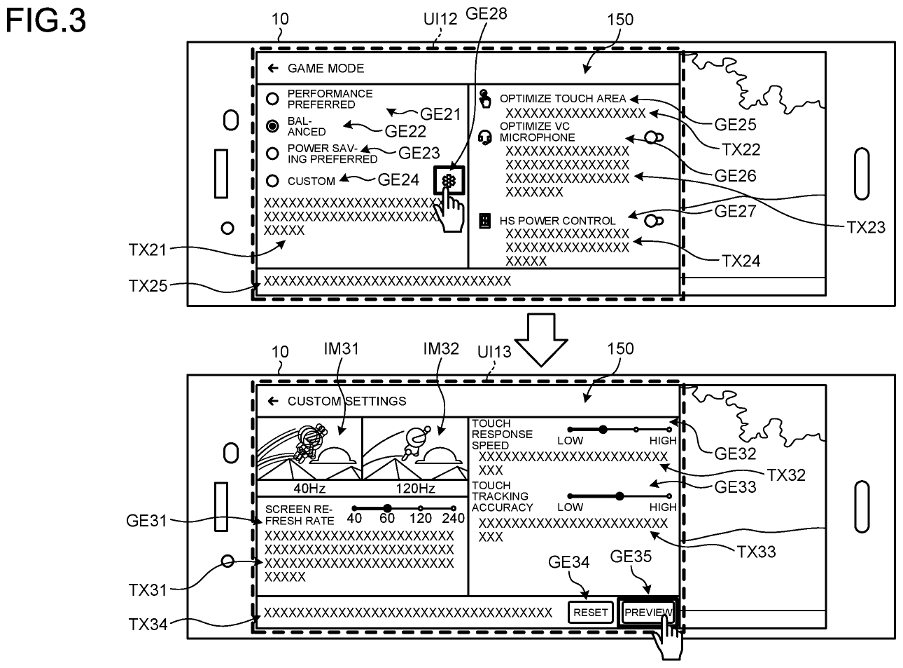

FIG. 3 is a diagram illustrating an example of an operation related to the menu display of the extension application according to the embodiment. The upper drawing of FIG. 3 is the same as the lower drawing of FIG. 2, and the description thereof will be omitted. Subsequently, the lower drawing of FIG. 3 illustrates a state in which the UI 13 for the custom settings of the extension application is superimposed and displayed on the external application by the user's touch interaction on the item GE28 displayed on the display unit 150. In other words, the user's touch interaction on the item GE28 causes transition of the screen of the extension application, from the UI 12 to the UI 13.

The UI 13 for the custom settings of the extension application is displayed on the display unit in the lower drawing of FIG. 3. In the lower drawing of FIG. 3, the UI 13 displayed on the display unit 150 includes a plurality of items (GE31 to GE33) of screen refresh rate (refresh rate), touch response speed, and touch tracking accuracy. Note that the refresh rate, the touch response speed, and the touch tracking accuracy will be described in detail later.

In the lower drawing of FIG. 3, the UI 13 displayed on the display unit 150 includes a plurality of texts (TX31 to TX34). The text TX31 is a text for supporting the setting of the refresh rate (item GE31), and shows, for example, “The higher value provides smoother screen display. However, the power consumption increases and the temperature of the main body may rise. If the temperature rises, this function becomes invalid.” Furthermore, the text TX32 is a text for supporting the setting of the touch response speed (item GE32), and shows, for example, “The higher setting provides the faster response of the touch interaction.” Furthermore, the text TX33 is a text for supporting the setting of the touch tracking accuracy (item GE33), and shows, for example, “The higher setting provides reliable tracking of the movements of the fingers.” Furthermore, the text TX34 is a text for supporting custom (item GE24) settings, and shows, for example, “These parameters may be automatically adjusted due to temperature rise.”

The UI 13 displayed on the display unit 150 in the lower drawing of FIG. 3 includes still images (IM31 and IM32) having refresh rates of 40 Hz and 120 Hz. In general, the refresh rate represents the number of times per unit time that the screen refreshes, and the higher the refresh rate, the smoother the image. In addition, the unit of the refresh rate is usually hertz (Hz). Furthermore, an image having a refresh rate of approximately 90 Hz or more is closer to an original image seen in the human's field of view. IM31 and IM32 show an example of how images look when the refresh rates are 40 Hz and 120 Hz. Note that IM31 and IM32 are examples, and the images displayed in the UI 13 are not particularly limited. In addition, IM31 and IM32 are not limited to the still images but may be moving images or the like. In addition, IM31 and IM32 are not limited to images having the refresh rates of 40 Hz and 120 Hz, but may be images having refresh rates of 160 Hz, 240 Hz, and the like. In addition, IM31 and IM32 may be images having refresh rates other than the refresh rates that can be selected from the item GE31.

In the lower drawing of FIG. 3, the UI 13 displayed on the display unit 150 includes a plurality of items (GE34 and GE35) of reset and preview. The item GE34 is an item for resetting the items (GE31 to GE33) of the refresh rate, touch response speed, and touch tracking accuracy. For example, the user's touch interaction on the item GE34 displayed on the display unit 150 returns setting values of the items (GE31 to GE33) to initial setting values. For example, the control unit 190 controls so that the user's touch interaction on the item GE34 changes the setting values to the initial setting values store in the storage unit 120. Note that a display position, display mode, and the like of the item GE34 are not particularly limited.

The item GE35 is an item for displaying UI 14 being a floating menu for the extension application. The lower drawing of FIG. 3 illustrates a state in which the user is about to perform the touch interaction on the display unit 150 in order to use the floating menu for the extension application. Note that a hand icon in the drawing represents a hand of the user who is about to perform the touch interaction.

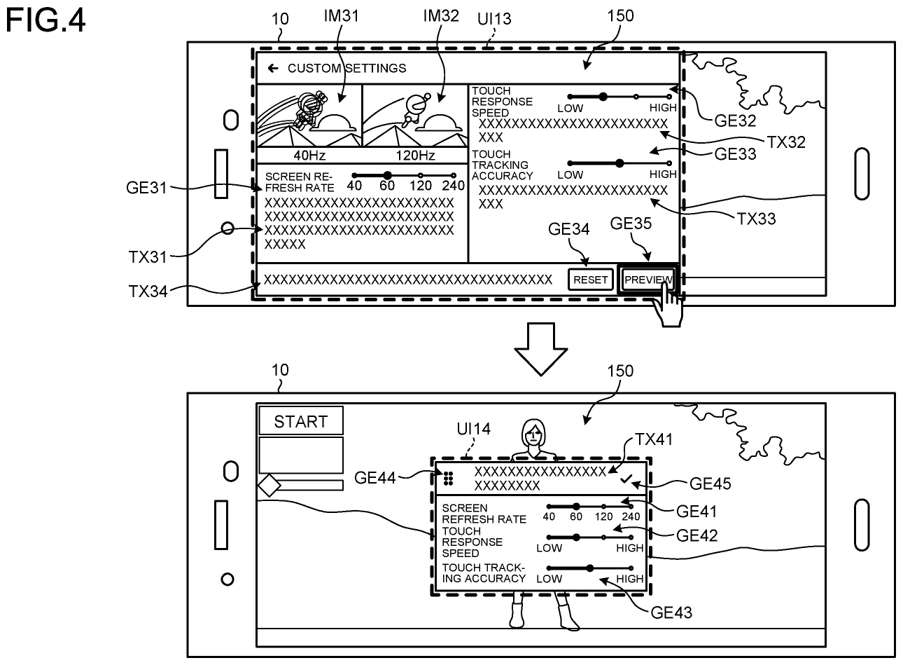

FIG. 4 is a diagram illustrating an example of an operation related to the menu display of the extension application according to the present embodiment. The upper drawing of FIG. 4 is the same as the lower drawing of FIG. 3, and the description thereof will be omitted. Subsequently, the lower drawing of FIG. 4 illustrates a state in which the UI 14 for the floating menu for the extension application is superimposed and displayed on the external application by the user's touch interaction on the item GE35 displayed on the display unit 150. In other words, the user's touch interaction on the item GE35 causes transition of the screen of the extension application, from the UI 13 to the UI 14. Note that a display position, display mode, and the like of the item GE35 are not particularly limited.

Here, the UI 14 will be described in comparison with the UI 13. For example, the UI 14 is a setting screen having reduced display items, modified UI layout, and a display size reduced as much as possible, while maintaining operability in the user's touch interaction for setting change as much as possible, relative to the UI 13. Therefore, in the UI 14, the setting screen has a reduced display size, as compared with the UI 13, and an area of a game screen overlapping the setting screen can be reduced. Therefore, the UI 14 facilitates viewing the game screen. Furthermore, the UI 14 makes it possible to perform the touch interactions on a larger number of buttons or objects that are arranged on the game screen and configured to receive the user's touch interaction, without changing the position of the setting screen, due to the reduced size of the setting screen, although the user needs to perform the touch interaction that has changed by the user, on the actual game screen, while confirming how the touch interaction has changed, until the user finds the satisfactory settings.

Furthermore, in the UI 13, the setting screen sometimes hides most of the game screen, as illustrated in the drawing, and thus, processing of stopping or temporarily stopping the operation of the game may be required, depending on the game. Meanwhile, the UI 14 has a size reduced not to interfere with the game screen, and it is possible for the UI 14 to be displayed as a floating icon on an upper layer while operating the game.

In the lower drawing of FIG. 4, the display unit displays the UI 14 being the floating menu for the extension application. In the lower drawing of FIG. 4, the UI 14 is displayed at the center portion of the display unit 150. In the lower drawing of FIG. 4, the UI 14 displayed on the display unit 150 includes a plurality of items (GE41 to GE43) of screen refresh rate (refresh rate), touch response speed, and touch tracking accuracy. Here, the items (GE41 to GE43) are similar to the items (GE31 to GE33). For example, the items (GE31 to GE33) are displayed as the items (GE41 to GE43). In other words, setting values of the items (GE41 to GE43) are the setting values having been set for the items (GE31 to GE33) immediately before transition from U 13 to U 14. Therefore, description of the items (GE41 to GE43) will be omitted.

In the lower drawing of FIG. 4, the UI 14 displayed on the display unit 150 includes a text TX41. The text TX41 is a text for supporting the setting of the items (GE41 to GE43) included in the UI 14, and shows, for example, “You can confirm whether the game environment is changed as intended by actual operation on the screen.”

In the lower drawing of FIG. 4, the UI 14 displayed on the display unit 150 includes an item GE44 that is an icon for the user to freely move the UI 14 on the screen on the display unit 150. The item GE44 is, for example, a portion that is touched by the user when the user performs the touch interaction. Note that a display position, display mode, and the like of the item GE44 are not particularly limited. For example, when the user performs the touch interaction, such as drag (or, drag and drop), on the item GE44 displayed on the display unit 150, the UI 14 is freely moved to a user's intended position. In this way, the display position of the UI 14 is controlled by the control unit 190 so as to be freely moved by the user. Note that the UI 14 is superimposed and displayed on the screen of the external application even during movement. In other words, the UI 14 is superimposed and displayed on the screen of the external application in a floating state. As a specific example, when the UI 14 displayed at an upper right portion of the display unit 150 is moved to an upper left portion of the display unit 150 by the user's touch interaction, the display position of the UI 14 is changed from the upper right portion to the upper left portion of the display unit 150.

In the lower drawing of FIG. 4, the UI 14 displayed on the display unit 150 includes an item GE45 that is an icon for the user to close a screen of the UI 14. Note that a display position, display mode, and the like of the item GE45 are not particularly limited. For example, when the user performs the touch interaction on the item GE45 displayed on the display unit 150, the screen of the UI 14 is closed. Note that operation for the extension application is immediately reflected, and therefore, the setting values having been set for the items (GE41 to GE43) immediately before closing the screen of the U 14 are reflected in the operation. Then, when the screen of the UI 14 is closed, the display unit returns to a state before activation of the extension application, and returns to a state in which the screen of the external application is displayed in full screen. Note that the present disclosure is not limited to this example, and the user's touch interaction on the item GE45 may transition the screen of the extension application from the UI 14 to any of the UI 11 to the UI 13. Alternatively, the UI 14 may transition to another UI screen, which is not illustrated.

Note that the UI settings having been changed in FIGS. 2 to 4 are stored in the storage unit 120 by the control unit 190, and thereafter, when the extension application is used, the stored UI settings are displayed on the UI screens. Furthermore, the UI settings may be associated with the external applications, and may be stored in the storage unit 120, for each external application. Furthermore, the UI settings may be associated with specific targets (e.g., firearms such as a gun, and scenes) of the external application, and may be stored in the storage unit 120, for each specific target of the external application.

Note that the touch interaction for displaying the UIs (the UI 11 to the UI 14) according to the present embodiment may be any operation. For example, as the touch interactions for displaying the UIs according to the present embodiment, tap, double tap, drag, pinch, wipe, and the like may be used. Furthermore, the display position of each UI according to the present embodiment is also not particularly limited. For example, the display position of the UI 12 is not limited to the left side of the display unit 150 as illustrated in the lower drawing of FIG. 2 or the same side as that of the UI 11, and the UI 12 may be arranged at various positions on the display unit 150. Furthermore, for example, the display position of the UI 14 is not limited to the center portion of the display unit 150 as illustrated in the lower drawing of FIG. 4, and the UI 14 may be arranged at various positions of the display unit 150. In addition, the display mode of each UI according to the present embodiment is also not particularly limited. For example, the UIs according to the present embodiment are superimposed and displayed on the screen of the external application, and therefore, each UI desirably has a shape, color, size, transmittance that do not interfere with the screen display of the external application as much as possible.

The UIs according to the present embodiment may be a transparent screen so as not to interfere with the screen display of the external application as much as possible. For example, the UIs according to the present embodiment may be a transparent screen through which the background of the external application can be visually recognized from an area of the UI screen. Furthermore, the control unit 190 may perform control to change the transmittance of the UI screen so as to visually recognize the background of the external application, on the basis of background information such as color density of the external application. Furthermore, the UIs according to the present embodiment may be a resizable screen so as not to interfere with the screen display of the external application as much as possible. When each UI according to the present embodiment has a high screen occupancy, the external application becomes difficult to see. Therefore, the control unit 190 may perform control to change the size of the UI screen so as to have a minimum value that does not interfere with the operation of the external application as much as possible.

Furthermore, the UI 11 to UI 13 according to the present embodiment are controlled by the control unit 190 to be in a non-display state by performing the touch interaction on an area other than the UI screen on the display unit 150 or when the UI screen is not operated for a certain period of time. In this way, the UI 11 to UI 13 according to the present embodiment are controlled by the control unit 190 to be in the non-display state when not used by the user. Note that the UI 14 according to the present embodiment is controlled by the control unit 190 not to be in the non-display state even when the touch interaction is performed on the area other than the UI screen on the display unit 150 or when the UI screen is not operated for the certain period of time. In this way, the UI 14 according to the present embodiment is controlled by the control unit 190 not to be in the non-display state even while not used by the user. Therefore, the user can appropriately adjust the settings on the UI screen while confirming the operation of the external application in an area other than the UI screen on the display unit 150, and therefore, the UI 14 can explicitly provide optimum settings to the user.

The refresh rate, the touch response speed, and the touch tracking accuracy according to the present embodiment will be described below.

The refresh rate represents the number of times per unit time that the screen refreshes. In addition, the higher the refresh rate, the smoother the image, and the lower the refresh rate, the more afterimage feeling is emphasized. In the item GE31, the refresh rate can be selected from 40 Hz, 60 Hz, 120 Hz, and 240 Hz. In the lower drawing of FIG. 3, a state of selecting 60 Hz from the above refresh rates is illustrated as an example. Note that the present embodiment, there is no correspondence relationship between the refresh rate selected in the item GE31 and the refresh rate of the still images (IM31 and IM32). Therefore, even if the refresh rate of the item GE31 is changed, the still images (IM31 and IM32) are not changed. As described above, the lower the refresh rate, the more the afterimage feeling is emphasized. Therefore, it can be understood that the refresh rate relates to setting related to the suppression of the afterimage feeling in the operation of the external application. Note that in a case where the refresh rate is 240 Hz, a black image may be inserted 240 times instead of rewriting the displayed screen 240 times. In this configuration, it is possible to suppress the afterimage feeling by refreshing the image persistent in the user's vision with black insertion. This configuration is different from those of the refresh rates of 40 Hz, 60 Hz, and 120 Hz where the displayed screens are refreshed by the number of times indicated by the refresh rates.

The touch response speed and the touch tracking accuracy represent how fast or slow the touch response is, how finely the touch can be reproduced as intended by the user, and the like. Conventionally, a touch point has been estimated to some extent so as not to cause an erroneous operation or the like, and a reaction has been made at a point the most strongly pressed. However, in a case of playing a game or the like with a plurality of fingers, it may be better to completely trace the movements of the fingers, considering all touched points as the user's intention. Therefore, in some cases, it may be better for the user to freely change the sensitivity of a user's intended point. In addition, conventionally, such setting has needed to be determined by the user before the activation of the external application such as a game. However, in this case, it is necessary to move back and forth between the game screen and the setting screen in order to adjust the setting, and there has been room for further improving usability in order to obtain more comfortable user experience.

For example, the touch response speed is obtained by measuring a total time from user's touching to the finish of movement while touching, indicating detection related to the touching. For example, the higher the touch response speed increases, the shorter a time from pressing a shooting button to outputting a result. Therefore, the touch response speed strongly affects rendering or the like in the game. Therefore, it can be understood that the touch response speed relates to setting related to trackability on the time axis in the operation of the external application. In addition, for example, the touch tracking accuracy is obtained by measuring a total time from the user's touching to the finish of movement while touching, indicating detection related to the movement. For example, as the touch tracking accuracy is higher, not one point but more points are detected in a case where the user places a thumb on the screen. Therefore, the touch tracking accuracy strongly affects intermittent movement or the like in the game. Therefore, it can be understood that the touch tracking accuracy relates to setting related to followability based on resolution in the operation of the external application. Note that, in a case where the touch tracking accuracy does not include the user's pressing feeling or the like, it can be understood that the touch tracking accuracy relates to setting related to followability based on a static resolution in the operation of the external application.

### 2. MODIFICATIONS OF EMBODIMENT

The embodiments of the present disclosure have been described above. Subsequently, modifications of the embodiments of the present disclosure will be described. Note that the modifications described below may be applied to the embodiments of the present disclosure independently or in combination. Furthermore, the modifications may be applied instead of the configurations described in the embodiments of the present disclosure or may be additionally applied to the configurations described in the embodiments of the present disclosure.

In the above embodiments, adjustment of the three setting values of the refresh rate, the touch response speed, and the touch tracking accuracy has been described, but the present disclosure is not limited to this example. For example, the control unit 190 may perform control to change the sound reproduced by the external application. For example, the control unit 190 may perform control to adjust a specific band according to the external application such as to emphasize the specific band. Furthermore, for example, the control unit 190 may perform control to change the image quality of the external application. For example, the control unit 190 may perform control to adjust the color in the image quality in accordance with the external application, such as emphasizing a specific color (e.g., blue or yellow) in the image quality.

Furthermore, for example, in a case where a plurality of users making a group communicates with each other in the external application, the control unit 190 may perform control to suppress environmental sound (e.g., user's typing sound, motorcycle sound, and caster's voice in live). In this way, the control unit 190 may perform control to provide the band in which the voices of the users in the group are easy to hear. In this way, in the above embodiments, a noise reduction function may be provided. This configuration makes it possible to provide user experience that makes the user less tired even when the user plays the external application for a long time.

In the above embodiment, the UI 14 according to the present embodiment that transitions by the touch interaction on the UI 13 according to the present embodiment has been described, but the present disclosure is not limited to this example. For example, an icon for direct transition to the UI 14 may be displayed in the UI 11 or UI 12 according to the present embodiment. Furthermore, for example, an icon for direct display of the UI 14 may be displayed on the screen of the external application. Furthermore, for example, the control unit 190 may perform control by setting a trigger for direct display of the UI 14 to display the UI 14 by voice command, such as “Display the menu.” or to display the UI 14 by the touch interaction or the like on a camera key or a hardware key. This configuration makes it possible for the user to display the screen of the UI 14 with a shortcut, further improving usability.

In the above embodiment, the UI 13 according to the present embodiment that transitions by the touch interaction on the UI 12 according to the present embodiment has been described, but the present disclosure is not limited to this example. For example, an icon for direct transition to the UI 13 may be displayed in the UI 11 according to the present embodiment. Furthermore, for example, an icon for direct display of the UI 13 may be displayed on the screen of the external application. For example, the gear icon representing the item GE28 may be displayed in the UI 11 or on the screen of the external application. This configuration makes it possible for the user to display the screen of the UI 13 with a shortcut, further improving usability.

In the above embodiment, the refresh rate selected in the item GE31 and the refresh rate of the still images (IM31 and IM32) have described that have no correspondence relationship therebetween, but the present disclosure is not limited to this example, and the still images (IM31 and IM32) and the refresh rate selected in the item GE31 may be associated with each other. For example, when the refresh rate of the item GE31 has been changed, a still image before changing may be displayed in the IM31, and a still image after changing may be displayed in the IM32. This configuration makes it possible for the user to readily compare the refresh rates with each other, further improving usability.

In the above embodiment, freely moving the UI 14 according to the present embodiment by the user has been described, but the present disclosure is not limited to this example, and the control unit 190 may perform control to change the position of the UI 14 to a position not interfering with the user as much as possible. For example, the control unit 190 may perform control to identify the movement of the user's eyes and finger on the basis of position information of the finger with which the user touches and line-of-sight information so as to change the position of the UI 14 to the position not interfering with the user as much as possible. Here, in a case where the user is playing with a plurality of fingers, the movement of the fingers may be identified on the basis of the position information of all the plurality of fingers used by the user.

### 3. EXEMPLARY HARDWARE CONFIGURATION

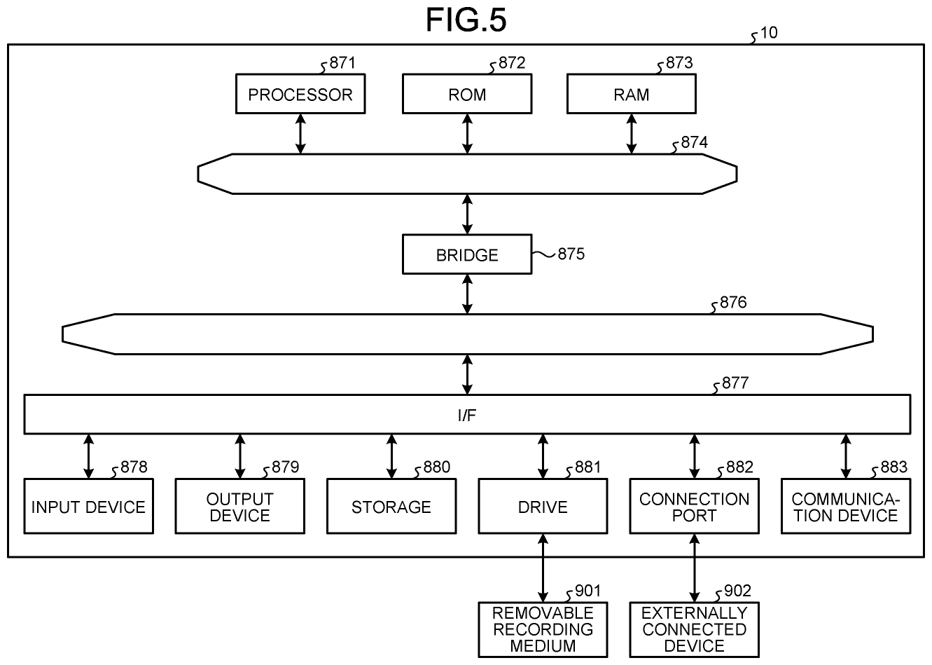

Next, an exemplary hardware configuration of the information processing device 10 according to an embodiment of the present disclosure will be described. FIG. 5 is a block diagram illustrating an exemplary hardware configuration of the information processing device 10 according to an embodiment of the present disclosure. Referring to FIG. 5, the information processing device 10 includes, for example, a processor 871, ROM 872, RAM 873, a host bus 874, a bridge 875, an external bus 876, an interface 877, an input device 878, an output device 879, a storage 880, a drive 881, a connection port 882, and a communication device 883. Note that the hardware configuration shown here is merely an example, and some of the component elements may be omitted. In addition, a component element other than the component elements shown here may be further included.

(Processor 871)

The processor 871 functions, for example, as an arithmetic processing device or a control device, and controls all or some of the operations of the component elements, on the basis of various programs recorded in the ROM 872, the RAM 873, the storage 880, or a removable recording medium 901.

(ROM 872 and RAM 873)

The ROM 872 is a unit that stores a program read by the processor 871, data used for calculation, and the like. The RAM 873 temporarily or permanently stores, for example, a program read by the processor 871, various parameters appropriately changing upon running the program, and the like.

(Host Bus 874, Bridge 875, External Bus 876, and Interface 877)

The processor 871, the ROM 872, and the RAM 873 are connected to each other, for example, via the host bus 874 configured to transmit data at high speed. Meanwhile, the host bus 874 is connected to, for example, the external bus 876 configured to transmit data at relatively low speed, via the bridge 875. In addition, the external bus 876 is connected to various component elements via the interface 877.

(Input Device 878)

For the input device 878, for example, a mouse, a keyboard, a touch-screen, a button, a switch, a lever, and the like are used. Furthermore, for the input device 878, a remote controller configured to transmit a control signal by using infrared ray or another radio wave is sometimes used. Furthermore, the input device 878 includes a voice input device such as a microphone.

(Output Device 879)

The output device 879 is a device, such as a display device including a cathode ray tube (CRT), LCD, or organic EL, an audio output device including a speaker or headphone, a printer, a mobile phone, or a facsimile, that is configured to visually or audibly notify the user of acquired information. Furthermore, the output device 879 according to the present disclosure includes various vibrating devices configured to output tactile stimulation.

(Storage 880)

The storage 880 is a device for storing various data. For the storage 880, for example, a magnetic storage device such as a hard disk drive (HDD), a semiconductor storage device, an optical storage device, a magneto-optical storage device, or the like is employed.

(Drive 881)

The drive 881 is, for example, a device that reads information recorded on the removable recording medium 901 such as a magnetic disk, optical disk, magneto-optical disk, or semiconductor memory and writes information on the removable recording medium 901.

(Removable Recording Medium 901)

The removable recording medium 901 is, for example, a DVD medium, a Blu-ray (registered trademark) medium, an HD DVD medium, various semiconductor storage media, or the like. As a matter of course, the removable recording medium 901 may be, for example, an IC card with a non-contact IC chip, an electronic device, or the like.

(Connection Port 882)

The connection port 882 is, for example, a port for connecting an externally connected device 902 such as a universal serial bus (USB) port, IEEE1394 port, small computer system interface (SCSI), RS-232C port, or optical audio terminal.

(Externally Connected Device 902)

The externally connected device 902 includes, for example, a printer, a portable music player, a digital camera, a digital camcorder, or an IC recorder.

(Communication Device 883)

The communication device 883 is a communication device for connection to a network, and is, for example, a communication card for wired or wireless LAN, Bluetooth (registered trademark), or wireless USB (WUSB), an optical communication router, an asymmetric digital subscriber line (ADSL) router, various communication modems, or the like.

### 4. CONCLUSION

As described above, the information processing device includes the control unit that executes a process of activating the second application for setting related to the operation of the first application, displaying the screen of the first application, superimposing the menu for changing the setting of the second application on a part of the screen, and operating the first application and the second application independently.

This configuration makes it possible to provide comfortable user experience and further improve usability.

Preferred embodiments of the present disclosure have been described above in detail with reference to the accompanying drawings, but the technical scope of the present disclosure is not limited to these examples. A person skilled in the art may obviously find various alternations and modifications within the technical concept described in claims, and it should be understood that the alternations and modifications will naturally come under the technical scope of the present disclosure.

Furthermore, the effects descried herein are merely illustrative or exemplified effects, and are not limitative. In other words, with or in the place of the above effects, the technology according to the present disclosure may achieve other effects that are clear to those skilled in the art based on the description of this specification.

Note that the present technology can also have the following configurations.

(1)
An information processing device including
a control unit that executes a process of:
activating a second application for setting related to the operation of a first application;
displaying a screen of the first application and superimposing a menu for changing the setting of the second application on a part of the screen; and
operating the first application and the second application independently.
   (2)
The information processing device according to (1), wherein
the control unit
executes a process for continuously displaying the menu on the screen of the first application even after the setting is changed.
   (3)
The information processing device according to (1) or (2), wherein
the control unit
executes a process for enabling movement of the menu on the screen of the first application.
   (4)
The information processing device according to any one of (1) to (3), wherein
the control unit
executes a process for providing the menu as a resizable screen.
   (5)
The information processing device according to any one of (1) to (4), wherein
the control unit
executes a process for providing the menu as a transparent screen.
   (6)
The information processing device according to any one of (1) to (5), wherein
the control unit,
when the setting has been changed, executes a process corresponding to the changed setting.
   (7)
The information processing device according to (6), wherein
the control unit
immediately reflects the changed setting in the operation.
   (8)
The information processing device according to any one of (1) to (7), wherein
the control unit
executes the process based on the setting including setting related to suppression of afterimage feeling in the operation.
   (9)
The information processing device according to any one of (1) to (8), wherein
the control unit
executes the process based on the setting including setting related to followability on a time axis in the operation.
   (10)
The information processing device according to any one of (1) to (9), wherein
the control unit
executes the process based on the setting including setting related to followability based on resolution in the operation.
   (11)
An information processing method including
an information processing device that executes a process of:
activating a second application for setting related to the operation of a first application;
displaying a screen of the first application and superimposing a menu for changing the setting of the second application on a part of the screen; and
operating the first application and the second application independently.
   (12)
An information processing program causing
an information processing device to execute a process of:
activating a second application for setting related to the operation of a first application;
displaying a screen of the first application and superimposing a menu for changing the setting of the second application on a part of the screen; and
operating the first application and the second application independently.

### REFERENCE SIGNS LIST

10 INFORMATION PROCESSING DEVICE
110 OPERATION UNIT
120 STORAGE UNIT
130 IMAGE CAPTURE UNIT
140 SENSOR UNIT
150 DISPLAY UNIT
160 VOICE INPUT UNIT
170 VOICE OUTPUT UNIT
180 SCREEN CAPTURE UNIT
190 CONTROL UNIT

1. An information processing device including a control unit that executes a process of:
activating a second application for setting related to the operation of a first application;
displaying a screen of the first application and superimposing a menu for changing the setting of the second application on a part of the screen; and
operating the first application and the second application independently.

2. The information processing device according to claim 1, wherein
the control unit
executes a process for continuously displaying the menu on the screen of the first application even after the setting is changed.

3. The information processing device according to claim 1, wherein
the control unit
executes a process for enabling movement of the menu on the screen of the first application.

4. The information processing device according to claim 1, wherein
the control unit
executes a process for providing the menu as a resizable screen.

5. The information processing device according to claim 1, wherein
the control unit
executes a process for providing the menu as a transparent screen.

6. The information processing device according to claim 1, wherein
the control unit,
when the setting has been changed, executes a process corresponding to the changed setting.

7. The information processing device according to claim 6, wherein
the control unit
immediately reflects the changed setting in the operation.

8. The information processing device according to claim 1, wherein
the control unit
executes the process based on the setting including setting related to suppression of afterimage feeling in the operation.

9. The information processing device according to claim 1, wherein
the control unit
executes the process based on the setting including setting related to followability on a time axis in the operation.

10. The information processing device according to claim 1, wherein
the control unit
executes the process based on the setting including setting related to followability based on resolution in the operation.

11. An information processing method including
an information processing device that executes a process of:
activating a second application for setting related to the operation of a first application;
displaying a screen of the first application and superimposing a menu for changing the setting of the second application on a part of the screen; and
operating the first application and the second application independently.

12. An information processing program causing
an information processing device to execute a process of:
activating a second application for setting related to the operation of a first application;
displaying a screen of the first application and superimposing a menu for changing the setting of the second application on a part of the screen; and
operating the first application and the second application independently.
